(19) United States
(12) Patent Application Publication
(10) Pub. No.: US 2025/0010924 A1
(43) Pub. Date: Jan. 9, 2025

(54) BED SYSTEM HAVING REMOVABLE PANELS

(71) Applicant: RSI North America, Inc., Fort Worth, TX (US)

(72) Inventors: Michael VOSS, Fort Worth, TX (US); Donavin HAWKEY, Mkondeni (ZA)

(21) Appl. No.: 18/893,274

(22) Filed: Sep. 23, 2024

Related U.S. Application Data
(63) Continuation of application No. PCT/US2023/016232, filed on Mar. 24, 2023.
(60) Provisional application No. 63/323,223, filed on Mar. 24, 2022.

(51) Int. Cl. B62D 33/033; B60R 9/02; B62D 33/03; B62D 33/037

(52) U.S. Cl. CPC B62D 33/033; B60R 9/02; B62D 33/03; B62D 33/037

(57) ABSTRACT

A vehicle bed includes a top surface, a front end and a rear end, a first side and a second side, and a removable side panel with a first end, a second end, a top side, a bottom side, an interior side, and an exterior side. The removable side panel further includes an inner panel having a first end and a second end coupled to an outer panel having a first end and a second end. Additionally, the first end of the inner panel is configured to extend from and retract into the first end of the removable side panel.

### CROSS-REFERENCE TO RELATED APPLICATIONS

The present application is a continuation of International Patent Application No. PCT/US2023/016232 filed Mar. 24, 2023 which claims the benefit of U.S. Provisional Patent Application No. 63/323,223 filed Mar. 24, 2022, the entirety of which are incorporated herein by reference.

### BACKGROUND

The present disclosure generally relates to a bed system having removable panels. Typically, a vehicle bed comprises a flat surface located behind a vehicle cabin. The vehicle bed may be used for a number of utility purposes, including transporting cargo. Further, vehicle beds may include panels that surround the flat surface of the vehicle bed. The panels may prevent cargo from falling off of the vehicle bed when the vehicle is moving. Additionally, a vehicle bed may include other structures. For example, a vehicle bed may include a rack system or a cap to cover or help secure cargo. Added structures can also be useful for providing a compartment for sleeping during overlanding, which consists of overland travel to remote destinations.

### SUMMARY

The present disclosure provides new and innovative systems, methods and apparatus for a bed system having removable panels. In an example, a vehicle bed includes a top surface, a front end and a rear end, a first side and a second side, and a removable side panel with a first end, a second end, a top side, a bottom side, an interior side, and an exterior side. The removable side panel further includes an inner panel having a first end and a second end coupled to an outer panel having a first end and a second end. Additionally, the first end of the inner panel is configured to extend from and retract into the first end of the removable side panel.

In another example, the bottom side of the removable side panel is coupled to the top surface of the vehicle bed, and the first end of the removable side panel is coupled to a front structure of the vehicle bed. The bottom side of the removable side panel may be coupled to the top surface of the vehicle bed by a hinge. The first end of the removable side panel may be further coupled to a front structure of the vehicle bed by a latch. The hinge and the latch may releasably couple the removable side panel to the vehicle bed.

In light of the disclosure herein and without limiting the disclosure in any way, in a first aspect of the present disclosure, which may be combined with any other aspect listed herein unless specified otherwise, a vehicle bed includes a top surface, a front end and a rear end, a first side and a second side, and a removable side panel with a first end, a second end, a top side, a bottom side, an interior side, and an exterior side.

In accordance with a second aspect of the present disclosure, which may be used in combination with any other aspect listed herein unless stated otherwise, the removable side panel includes an inner panel having a first end and a second end coupled to an outer panel having a first end and a second end, wherein the first end of the inner panel is configured to extend from and retract into the first end of the removable side panel.

In accordance with a third aspect of the present disclosure, which may be used in combination with any other aspect listed herein unless stated otherwise, at least one hinge couples the bottom side of the removable side panel to the top surface of the vehicle bed.

In accordance with a fourth aspect of the present disclosure, which may be used in combination with any other aspect listed herein unless stated otherwise, the at least one hinge includes a spring.

In accordance with a fifth aspect of the present disclosure, which may be used in combination with any other aspect listed herein unless stated otherwise, a first coupling couples the first end of the removable side panel to a front structure of the vehicle bed.

In accordance with a sixth aspect of the present disclosure, which may be used in combination with any other aspect listed herein unless stated otherwise, the first coupling includes a first latch configured to extend and retract a component to engage the front structure of the vehicle bed.

In accordance with a seventh aspect of the present disclosure, which may be used in combination with any other aspect listed herein unless stated otherwise, a second coupling couples the second end of the removable side panel to a post on the top surface of the vehicle bed.

In accordance with an eighth aspect of the present disclosure, which may be used in combination with any other aspect listed herein unless stated otherwise, the second coupling includes a second latch configured to extend and retract a component to engage an aperture in the post.

In accordance with a ninth aspect of the present disclosure, which may be used in combination with any other aspect listed herein unless stated otherwise, a second coupling couples the second end of the removable side panel to a rear panel of the vehicle bed.

In accordance with a tenth aspect of the present disclosure, which may be used in combination with any other aspect listed herein unless stated otherwise, the first end of the inner panel includes an engaging member to engage at least one of a plurality of slots on the top surface of the rear end of the vehicle bed.

In accordance with an eleventh aspect of the present disclosure, which may be used in combination with any other aspect listed herein unless stated otherwise, the outer panel further includes a plurality of ridges and the inner panel further includes a plurality of ridges.

In accordance with a twelfth aspect of the present disclosure, which may be used in combination with any other aspect listed herein unless stated otherwise, the inner panel further includes a notch and the outer panel further includes a protrusion wherein the notch is configured to contact the protrusion to prevent overextension.

In accordance with a thirteenth aspect of the present disclosure, which may be used in combination with any other aspect listed herein unless stated otherwise, a third coupling couples the removable side panel to the vehicle bed.

In accordance with a fourteenth aspect of the present disclosure, which may be used in combination with any other aspect listed herein unless stated otherwise, a third coupling is configured to enable rotation of the removable side panel with respect to the vehicle bed such that a surface of the interior side of the removable side panel is approximately co-planar with the top surface of the vehicle bed.

In accordance with a fifteenth aspect of the present disclosure, which may be used in combination with any other aspect listed herein unless stated otherwise, the vehicle bed includes a first side section, a middle section, and a second side section.

In accordance with a sixteenth aspect of the present disclosure, which may be used in combination with any other aspect listed herein unless stated otherwise, the first side of the vehicle bed includes a drawer.

In accordance with a seventeenth aspect of the present disclosure, which may be used in combination with any other aspect listed herein unless stated otherwise, the first side of the vehicle bed includes a first side storage compartment.

In accordance with an eighteenth aspect of the present disclosure, which may be used in combination with any other aspect listed herein unless stated otherwise, the vehicle bed includes a first side section, a second side second, and a middle section having a first side storage compartment, a middle storage compartment, and a second side storage compartment.

In accordance with a nineteenth aspect of the present disclosure, which may be used in combination with any other aspect listed herein unless stated otherwise, the middle section further includes a plurality of inserts to complementarily engage the removal side panel.

In accordance with a twentieth aspect of the present disclosure, which may be used in combination with any other aspect listed herein unless stated otherwise, the vehicle bed includes a plurality of interior apertures on the top surface of the vehicle bed.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates a vehicle bed, according to various examples of the present disclosure;

FIGS. 2A-B illustrate vehicle beds from a side-view, according to various examples of the present disclosure;

FIGS. 3A-B illustrate vehicle beds having a top surface, according to various examples of the present disclosure;

FIG. 4 illustrates a first side section of a vehicle bed, according to various examples of the present disclosure;

FIG. 5 illustrates a middle section of a vehicle bed, according to various examples of the present disclosure;

FIG. 6 illustrates a vehicle bed having removable panels, according to various examples of the present disclosure;

FIGS. 7A-D illustrate couplings of the vehicle bed, according to various examples of the present disclosure;

FIG. 8 illustrates a hinge, according to various examples of the present disclosure;

FIG. 9 illustrates a latch, according to various examples of the present disclosure;

FIG. 10 illustrates a middle section of a vehicle bed, according to various examples of the present disclosure;

FIG. 11 illustrates a removable side panel, according to various examples of the present disclosure;

FIG. 12 illustrates a removable side panel having a lock assembly, according to various examples of the present disclosure;

FIG. 13 illustrates a middle section of a vehicle bed, according to various examples of the present disclosure;

FIG. 14 illustrates a vehicle bed, according to various examples of the present disclosure;

FIG. 15 illustrates a vehicle bed having an adventure rack, according to various examples of the present disclosure;

FIG. 16 illustrates a vehicle bed having a cap system, according to various examples of the present disclosure; and

FIGS. 17A-B illustrate vehicle beds, according to various examples of the present disclosure.

### DETAILED DESCRIPTION OF EXAMPLE EMBODIMENTS

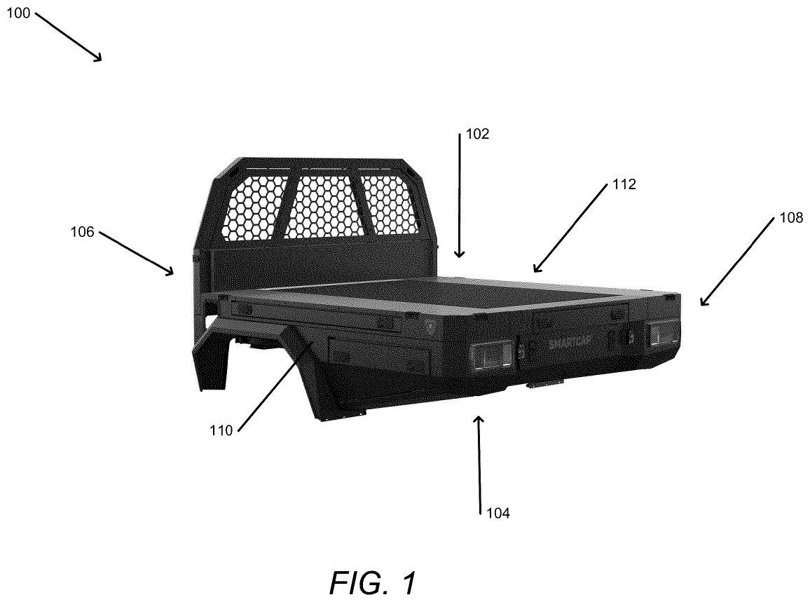

FIG. 1 illustrates a vehicle bed, according to various examples of the present disclosure. The vehicle bed 100 comprises a top surface 102, a bottom surface 104, a front end 106, a rear end 108, a first side 110, and a second side 112. When mounted on a vehicle, the front end 106 may be directly adjacent to the vehicle cabin while the rear end 108 is adjacent to the rear of the vehicle. Further, the top surface 102 faces upward when the vehicle is approximately parallel to the ground while the bottom surface 104 faces downward, toward the chassis of the vehicle. The top surface 102 may be used for a number of utility purposes, including storage or transporting cargo.

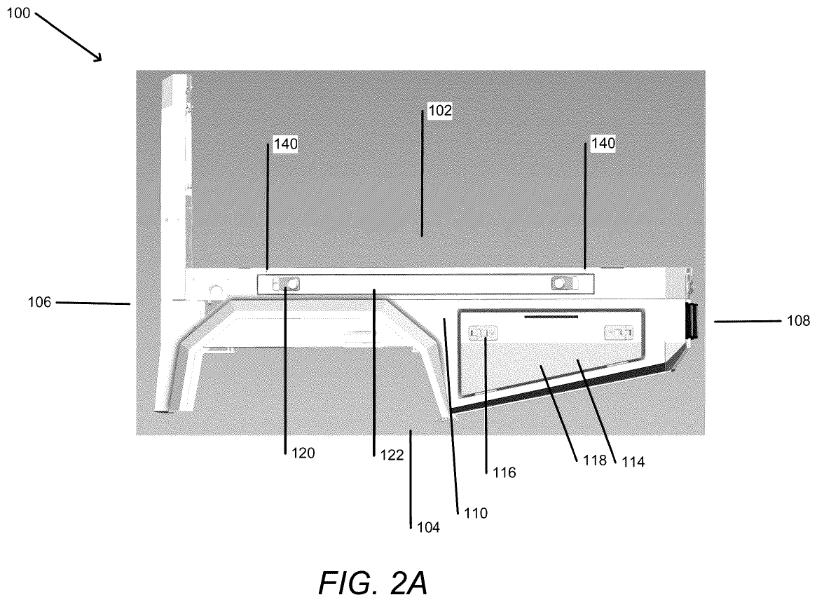

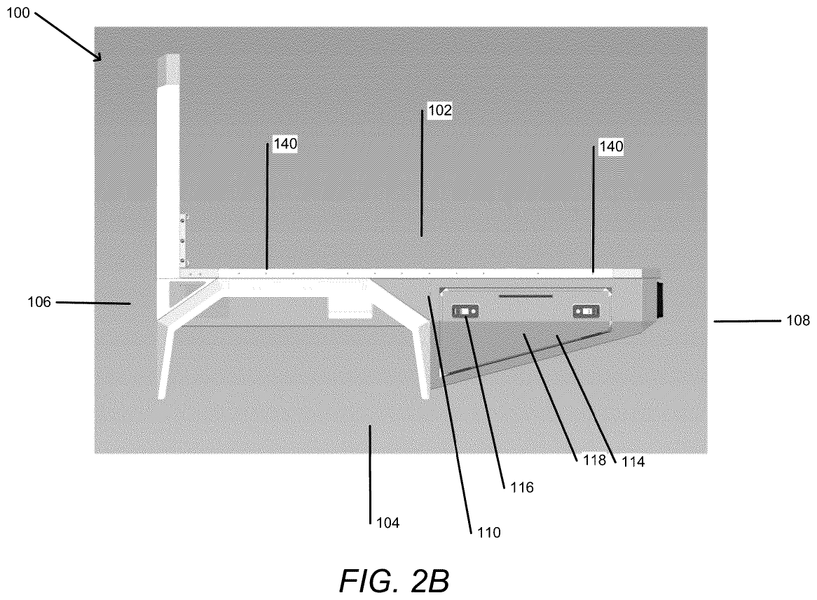

FIGS. 2A-B illustrate vehicle beds from a side-view, according to various examples of the present disclosure. The vehicle bed 100 comprises a top surface 102, a bottom surface 104, a front end 106, a rear end 108, a first side 110, and a second side 112 (not shown). The first side 110 further comprises a compartment 114 having a panel 118 and a first lock 116. The compartment 114 is accessible from the first side 110 of the vehicle bed 100. In an example, the compartment 114 can be used for storage with the first lock 116 keeping the contents secure. To use the compartment 114, a user may unlock one or more first lock 116 and open the panel 118, which is hingedly coupled to the vehicle bed 100.

In many embodiments, the first side 110 further comprises a drawer 122 having a second lock 120. The drawer 122 is accessible from the first side 110 of the vehicle bed 100. In an example, the drawer 122 can be used for storage with the second lock 120 keeping the contents secure. To use the drawer 122, a user may unlock one or more second lock 120 and slide the drawer 122 outward, extending away from the first side 110 of the vehicle bed 100. In many embodiments, the number and location of the second lock 120 can be varied. For example, the drawer 122 may comprise several locks for added security. In another example, the drawer 122 may comprise a single lock for ease of access. Further, the drawer 122 and the compartment 114 may be duplicated and added to the second side 112 of the vehicle bed 100 providing an additional compartment and an additional drawer for added storage. In several embodiments, as shown in FIG. 2B, the first side 110 may not include a drawer, leading to cost and weight savings.

In a number of embodiments, the first side 110 further comprises a plurality of external apertures 140. In FIG. 2A, the plurality of external apertures 140 are located above the drawer 122. In many embodiments, the number and location of the plurality of external apertures 140 can be varied. The plurality of external apertures 140 may be used to secure cargo on the top surface 102 of the vehicle bed 100. In an example, cargo is placed on the top surface 102 of the vehicle bed 100. To secure the cargo, ropes or straps can be placed around the cargo and tied or clipped to, for example, eye bolts that engage the plurality of external apertures 140. The plurality of external apertures 140 may have various uses besides securing cargo.

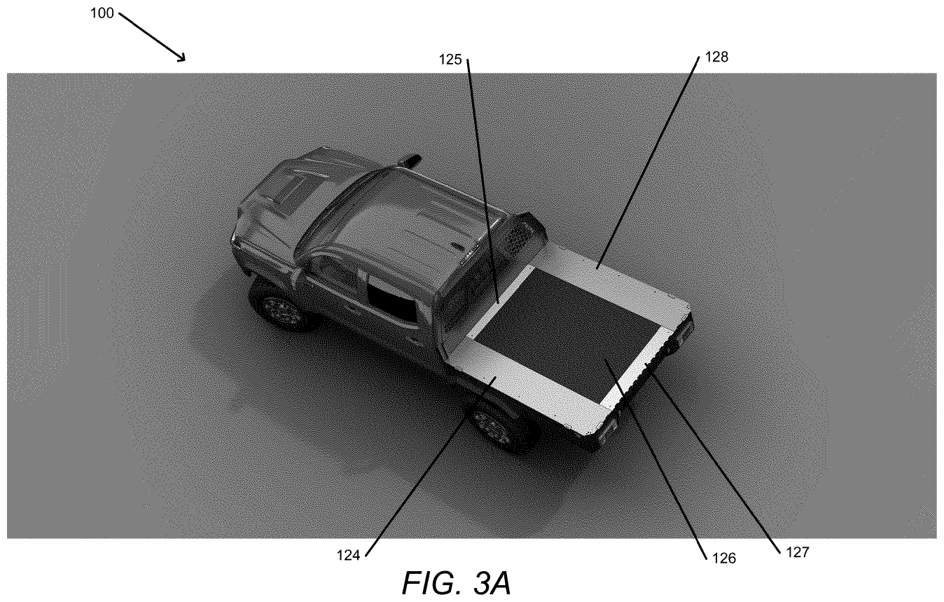

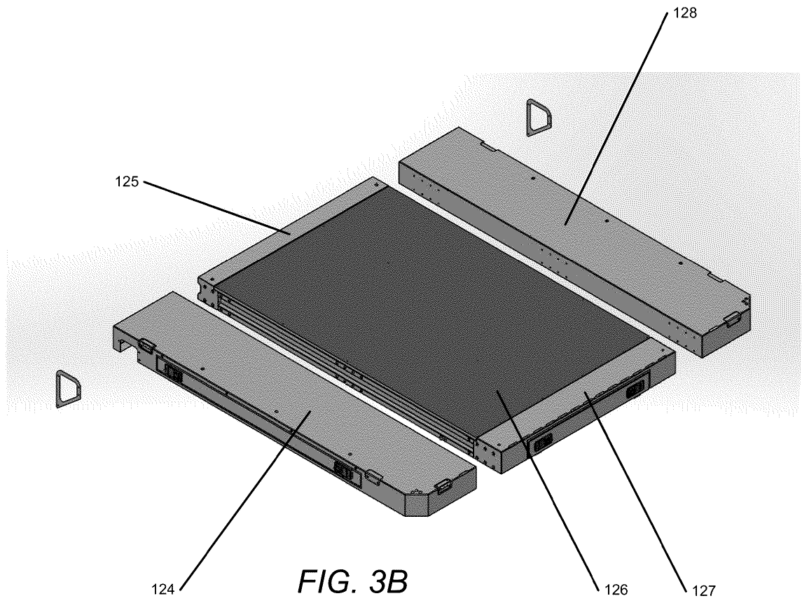

FIGS. 3A-B illustrate vehicle beds having a top surface, according to various examples of the present disclosure. The vehicle bed 100 may further comprise a first side section 124, a middle section 126, and a second side section 128. In various embodiments, the first side section 124, the middle section 126, and the second side section 128 run parallel to the chassis frame of the vehicle. Further, the vehicle bed 100 comprising a first side section 124, a middle section 126, and a second side section 128 may provide a number of advantages. For example, if one section of the vehicle bed 100 is damaged, the damaged portion can be replaced without replacing the non-damaged portion, saving time and costs. In another example, the material of each portion can be varied to increase durability or increase weight savings. In a number of embodiments, the middle section 126 may be made from a Wisa Hex Birch Play panel. The Wisa Hex Birch Play panel provides increased durability, increased weight savings, and an anti-skid surface to prevent any cargo from moving in while the vehicle moves. Further, the Wisa Hex Birch Play panel can be easily replaced if damaged. In many embodiments, the middle section 126 may further comprise a front top surface section 125 and a rear top surface section 127. FIG. 3B depicts a disassembled view of the first side section 124, the middle section 126, and the second side section 128, which demonstrates how a single section can be replaced. In an example, the Wisa Hex Birch Play panel of the middle section 126 is damaged. A user may remove the Wisa Hex Birch Play panel from the middle section 126 without replacing the first side section 124 or the second side section 128.

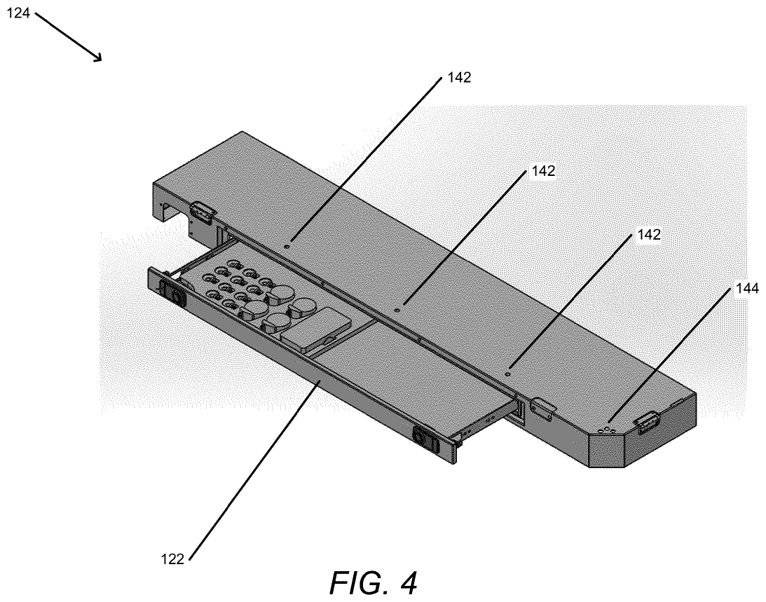

FIG. 4 illustrates a first side section of a vehicle bed, according to various examples of the present disclosure. In a number of embodiments, the first side section 124 may be made of steel to provide durability with an increased carrying capacity. For example, the vehicle bed 100 may be used to transport a second vehicle, such as an all-terrain vehicle, or may have cargo loads placed onto the vehicle bed 100 from any direction. Thus, a first side section 124 made of steel would be advantageous for maintaining the integrity of the edge of the top surface 102 while also providing ease of loading from the side or corner areas. The first side section 124 may house the drawer 122, which may further include apertures and notches designed to complement tie-downs and other frequently used tools. By housing the drawer 122, the first side section 124 provides dual functionally. The first side section 124 comprises a part of the top surface 102 of the vehicle bed 100. The first side section 124 also provides storage with the drawer 122. Further, the first side section 124 is configured such that housing the drawer 122 does not negatively impact the overall carrying capacity or durability of the vehicle bed 100. In various embodiments, the first side section 124 may further comprise a plurality of corner apertures 144. The plurality of corner apertures 144 may also be used to connect various attachments to the top surface 102 of the vehicle bed 100. In various embodiments, the first side section 124 may further comprise a plurality of interior apertures 142. In many embodiments, the features of the first side section 124 can be duplicated with the second side section 128.

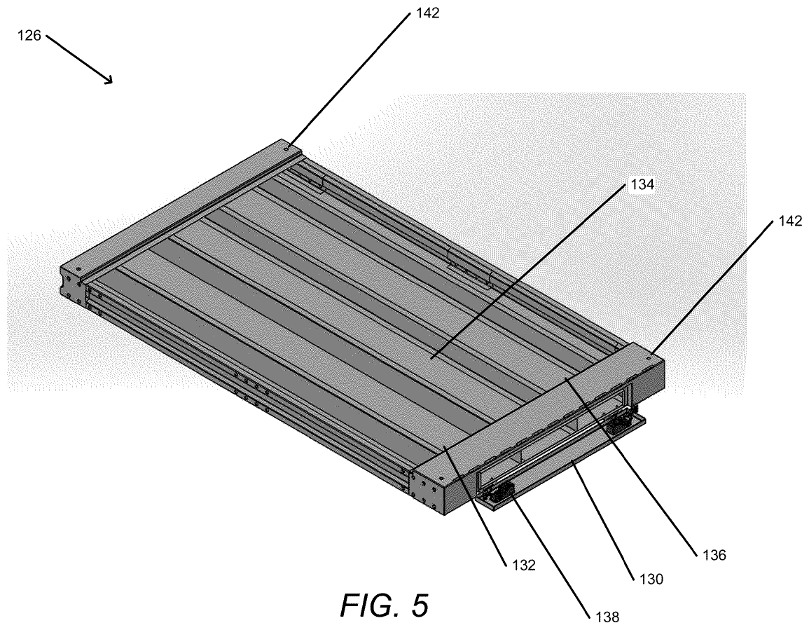

FIG. 5 illustrates a middle section of a vehicle bed, according to various examples of the present disclosure. In a number of embodiments, the middle section 126 may comprise a first side storage compartment 132, a middle storage compartment 134, and a second side storage compartment 136 accessible from the rear end 108 of the vehicle bed 100. The middle section 126 may further comprise a door 130 hingedly coupled to vehicle bed 100 for accessing the first side storage compartment 132, the middle storage compartment 134, and the second side storage compartment 136. A lock 138 may be coupled to the door 130 for securing the storage compartments. In many embodiments, the number and shape of the storage compartments can be varied to complement specific cargo. Further, the number and position of the lock 138 may be varied. By providing storage, the middle section 126 provides dual functionality. The middle section 126 comprises the top surface 102 of the vehicle bed 100 and provides storage without compromising the durability and hauling capacity of the vehicle bed 100.

In a number of embodiments, the middle section 126 may further comprise a plurality of interior apertures 142. The plurality of interior apertures 142 may be used to secure cargo. Similar to the plurality of external apertures 140, the plurality of interior apertures 142 may receive eye bolts, which can be used at attachment points to anchor ropes, straps, or clips to secure cargo on the top surface 102 of the vehicle bed 100. Further, the plurality of interior apertures 142 may be used to mount various attachments.

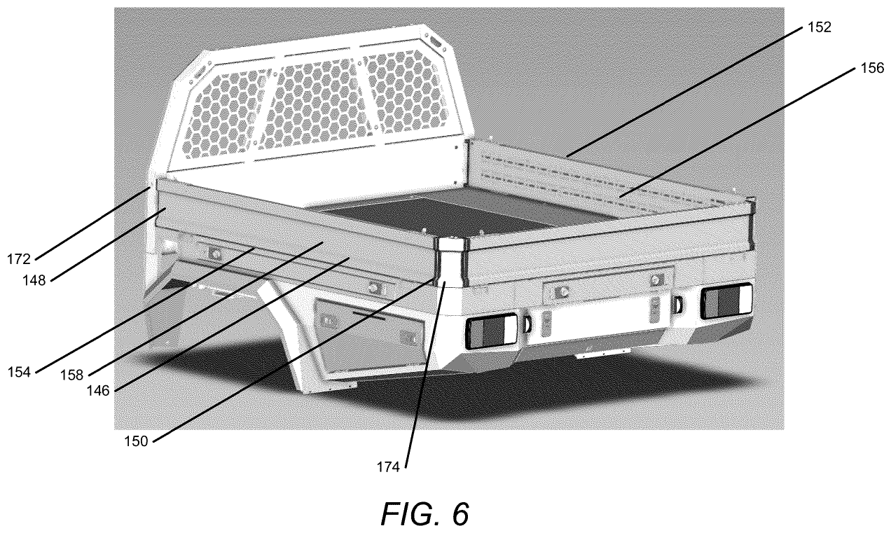

FIG. 6 illustrates a vehicle bed having a removable side panel, according to various examples of the present disclosure. The removable side panel 146 comprises a first end 148, a second end 150, a top side 152, a bottom side 154, an interior side 156, and an exterior side 158. When the removable side panel 146 is mounted on the vehicle 100, the first end 148 is adjacent to the front end 106 of the vehicle bed 100, and the second end 150 is adjacent to the rear end 108 of the vehicle bed 100. Further, the interior side 156 faces inward toward the top surface 102 of the vehicle bed 100, and the exterior side 158 faces outward away from the top surface 102 of the vehicle bed 100. The top side 152 of the removable side panel 146 faces upward in the same direction as the top surface 102 of the vehicle bed 100. The bottom side 154 of the removable side panel 146 faces downward towards the chassis of the vehicle. In various embodiments, the bottom side 154 is coupled to the top surface 102 of the vehicle bed 100. In many embodiments, the first end 148 of the removable side panel 146 is coupled to a structure 172 of the vehicle bed 100 located at the front end 106 of the vehicle bed 100. In an example, the structure 172 may comprise a post. In another example, the structure 176 may comprise a panel. In a number of embodiments, the second end 150 of the removable side panel 146 is coupled to a post 174 mounted on the vehicle bed 100 at the rear end 108 of the vehicle bed 100. In many embodiments, the post 174 is mounted, with any number of securing members, onto the plurality of corner apertures 144 on the top surface 102 of the vehicle bed 100.

In a number of embodiments, the plurality of interior apertures 142 may be used to secure cargo while the removable side panel 146 is coupled to the vehicle bed 100. In an example, the width of the removable side panel 146 is such that the removable side panel 146 does not cover the plurality of interior apertures 142 when coupled to the vehicle bed 100. In another example, the removable side panel 146 is coupled to the vehicle bed 100 with cargo. To secure the cargo, eye bolts can engage the plurality of interior apertures 142 to act as anchoring points for straps, rope, or clips for securing the cargo.

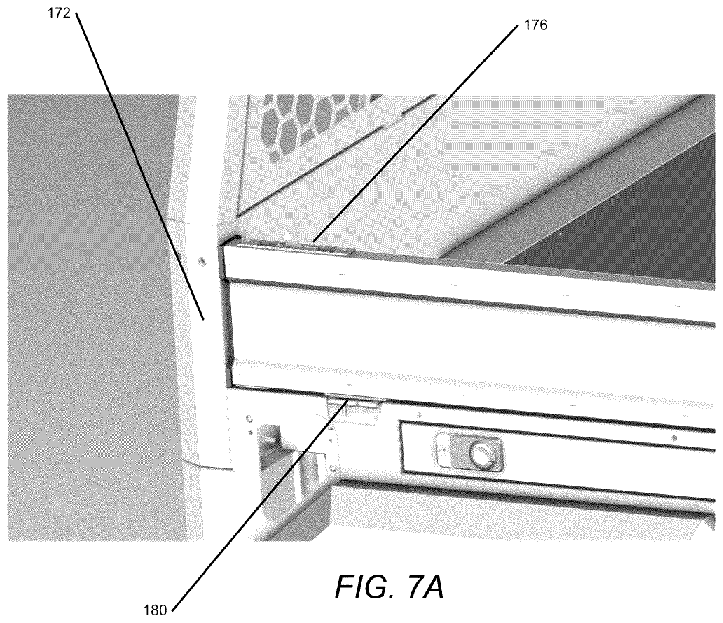

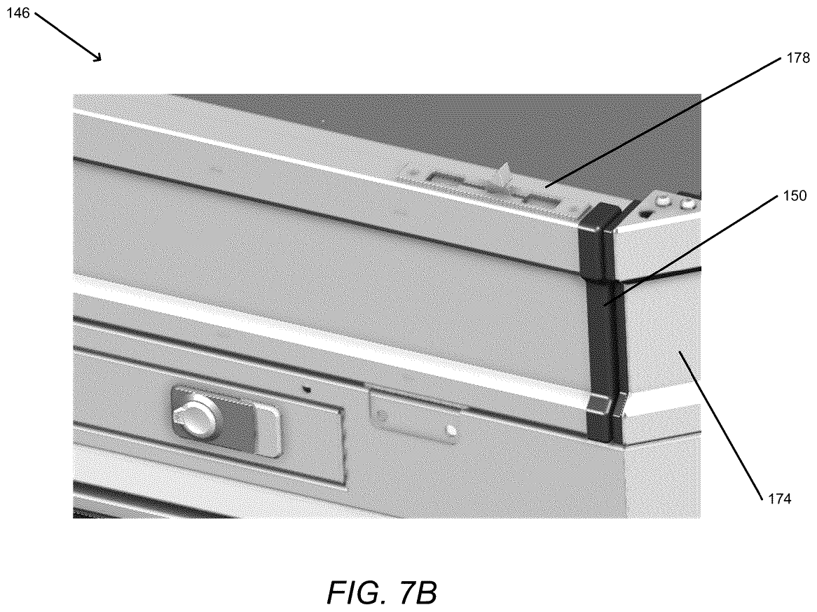

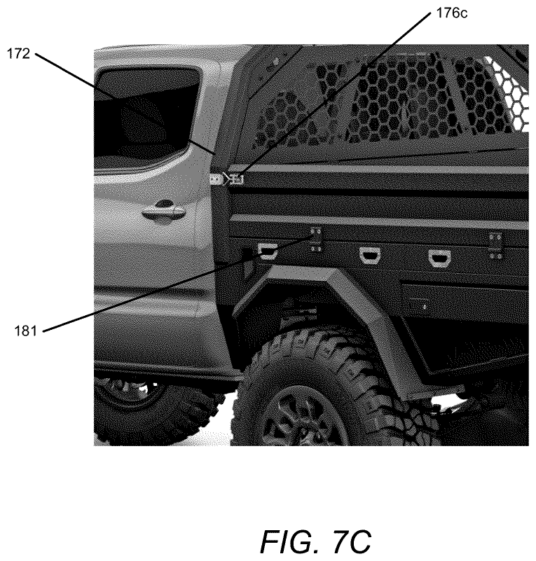

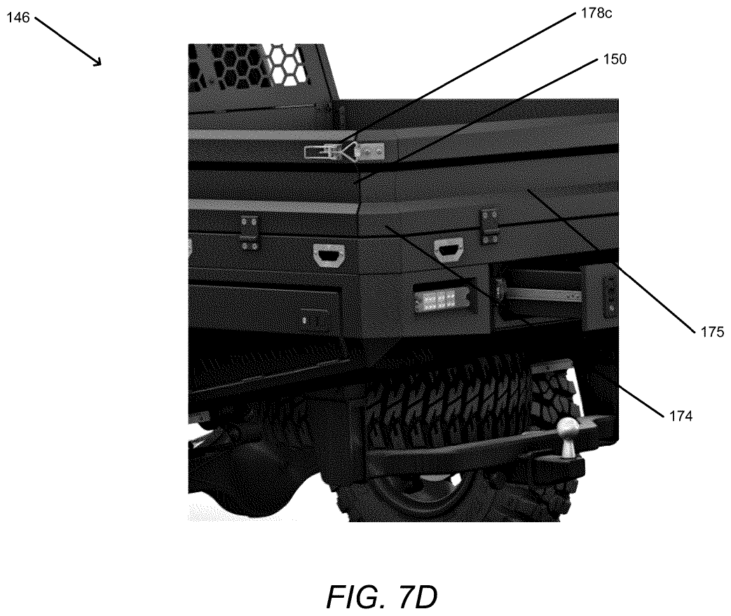

FIGS. 7A-D illustrate couplings of the vehicle bed, according to various examples of the present disclosure. As shown in FIGS. 7A-B, the removable side panel 146 may further include at least one hinge 180 located on the bottom side 154 to couple the bottom side 154 of the removable side panel 146 to the top surface 102 of the vehicle bed 100. In many embodiments, the at least one hinge 180 may be located at approximately the first end 148 and the second end 150 of the removable side panel 146 providing two coupling points. The removable side panel 146 may further comprise a first latch 176 to couple the first end 148 of the removable side panel 146 to the structure 172 of the vehicle bed 100 located at the front end 106 of the vehicle bed. The removable side panel 146 may further comprise a second latch 178 to couple the second end 150 of the removable side panel 146 to the post 174 mounted on the vehicle bed 100 at the rear end 108 of the vehicle bed 100.

FIGS. 7C-D illustrate couplings of the vehicle bed, according to various examples of the present disclosure. As shown in FIGS. 7C-D, the removable side panel 146 may further comprise a first latch assembly 176c to couple the first end 148 of the removable side panel 146 to the structure 172 of the vehicle bed 100 located at the front end 106 of the vehicle bed. The removable side panel 146 may also include a hinge 181, which allows a user to quickly remove the removable side panel 146 from the vehicle bed 100. The hinge 181 is located adjacent to the bottom side 154 of the removable side panel 146 to couple the bottom side 154 of the removable side panel 146 to the top surface 102 of the vehicle bed 100. In many embodiments, the number and position of the hinge 181 may be varied. The removable side panel 146 may further comprise a second latch assembly 178c, shown in FIG. 7D, to couple the second end 150 of the removable side panel 146 to the rear panel 175 which is mounted on the vehicle bed 100 at the rear end 108 of the vehicle bed 100. In many embodiments, the post 174 is removed and an end of the rear panel 175 provides stability through the first latch assembly 176c. In an alternative embodiment, and the second latch assembly 178c may couple to the post 174 mounted on the vehicle bed 100 at the rear end 108.

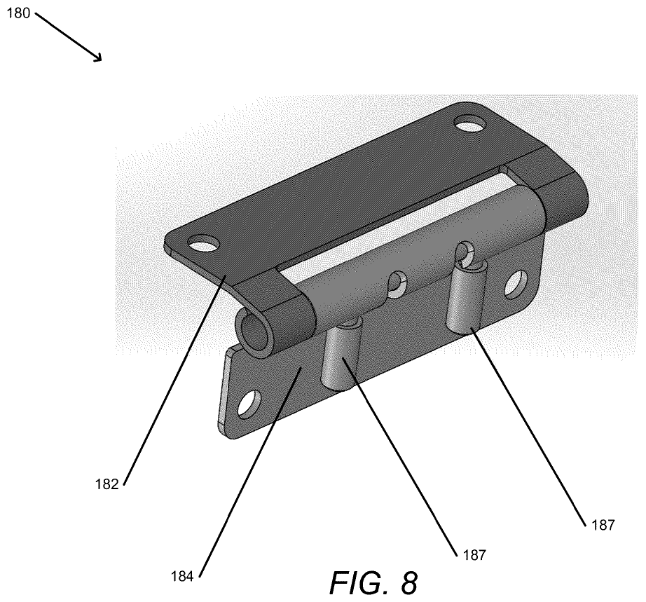

FIG. 8 illustrates a hinge, according to various examples of the present disclosure. The at least one hinge 180 comprises a first portion 182 and a second portion 184. The first portion 182 is fixed to the bottom surface 154 of the removable side panel 146, and the second portion 184 is fixed to the top surface 102 of the vehicle bed 100. The hinge 180 further comprises a spring to urge pins located in the second portion 184 of the hinge 180 in an outward direction. When the pins are urged into an outward direction, the pins securely engage the first portion 182. The hinge 180 is in the locked position when the first portion 182 and the second 184 are coupled together by the pins. To uncouple the first portion 182 and the second portion 184 and thereby uncouple the removable side panel 146 and vehicle bed 100 at the hinge location, a user may push a plurality of protrusions 187 inwards against the spring. When forced inward, the pins retract from the first portion 182 uncoupling the first portion 182 and the second portion 184. Further, the plurality of protrusions 187 may be rotated upward to fix hinge 180 in the uncoupled position. The hinge 180 is configured to allow a user to uncouple the first portion 182 and the second portion 184 using one hand while maintaining a secure coupling when the hinge 180 is in the locked position.

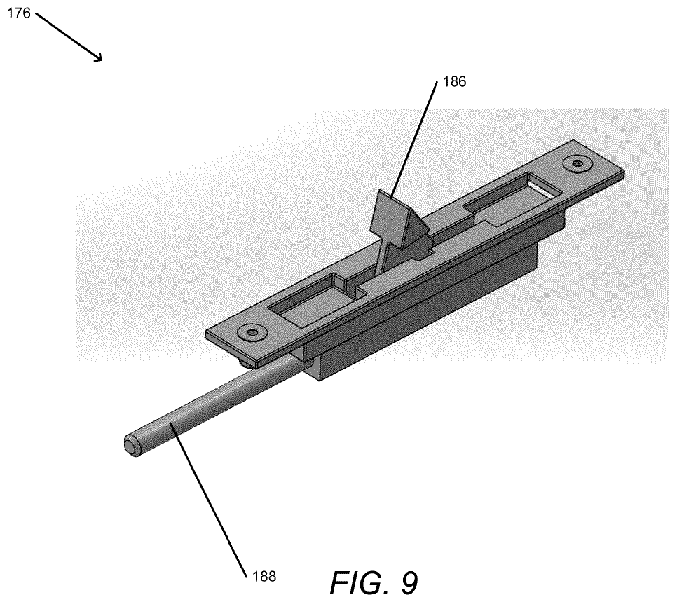

FIG. 9 illustrates a latch, according to various examples of the present disclosure. The first latch 176 includes an actuator 186 and a pin 188. The first latch 176 comprises an extended position and a retracted position. In the extended position, the pin 188 is extended to engage an aperture in the structure 172 of the vehicle bed 100 to secure the first end 148 of the removal side panel 146 to the vehicle bed 100. In the retracted position, the pin 188 is retracted to disengage an aperture in the structure 172 of the vehicle bed 100. The actuator 186 is configured to alter the position of the pin 188. When a user pushes down on the actuator 186, the pin 188 is retracted. When a user pulls the actuator upward, the pin is extended and engages the structure 172. In many embodiments, the first latch 176 is identical to the second latch 178. In an example, the second latch 178 is located at approximately the second end 150 of the removable side panel 146. When in the extended position, the second latch 178 secures the second end 150 of the removable side panel 146 to the post 174 mounted on the top surface 102 of the vehicle bed 100.

In many embodiments, the first end 148 of the removable side panel 146 may further comprise a third coupling to couple the removable side panel 146 to the vehicle bed 100. In an example, the third coupling comprises a cable connected from interior side 156 of the removable side panel near the top side 152 to the structure 172 of the vehicle bed 100. In another example, the cable comprises such a length that the interior side 156 of the removable side panel 146 can be flush with the top surface 102 of the vehicle bed. For example, the at least one hinge 180 may be in the locked position. When a user places the first latch 176 and the second latch 178 in the retracted position, the removable side panel 146 is free to rotate about the at least one hinge 180. The cable may be a length, such that it restricts rotation of the removable side panel 146 when the removable side panel 146 rotates about the at least one hinge 180 in the locked position. The cable may restrict the rotation causing the removable side panel 180 to rotate approximately 90 degrees from the mounted position to form a flush surface between the top surface 102 of the vehicle bed 100 and the interior side 156 of the removable side panel 146. In the described configuration, the interior side 156 of the removable side panel 146 may be used as a flat surface. The interior side 156 may additionally be used as an added flat surface to transport cargo. In many embodiments, the cable may be adjusted to various lengths to restrict the rotation of the removable side panel 146 to a desired degree. Further, the cable may be removed, such that the removable side panel 146 rotation is not restricted by a third coupling.

In an example, the removable side panel 146 can be removed from the vehicle bed 100 by a user. Beginning with the removable side panel 146 in the mounted position, the user may uncouple the at least one hinge 180, the first latch 176, the second latch 178, and the third coupling. To uncouple the bottom surface 154 of the removable side panel 146 from the top surface 102 of the vehicle bed 100, the user may uncouple the at least one hinge 180 by forcing the protrusions 187 inward to uncouple the first portion 182 of the at least one hinge 180 from the second portion 184 of the hinge 180. Next, the user may actuate the first latch 176 to uncouple the first end 148 of the removable side panel 146 from the structure 172 of the vehicle bed 100 and also actuate the second latch 178 to uncouple the second end 150 of the removable side panel 146 from the post 174. To actuate the first latch 176 and the second latch 178, a user may pull the actuator 186 upward retracting the pin 188 disengaging the first latch 176 and the second latch 178 from the corresponding component. In various embodiments with a third coupling, the user may, for example, unclip the cable from the removable side panel 146. Once the user uncouples each coupling, the user may remove the removable side panel 146 from the vehicle bed 100. Further, the user may remove the post 174 to provide a continuous flat surface. The user may perform the uncoupling steps in any order. Once the removable side panel 146 is removed, a user may use the middle section 126 of the vehicle bed 100 to store the removable side panel 146 in the first side storage compartment 132, the middle storage compartment 134, or the second side storage compartment 136.

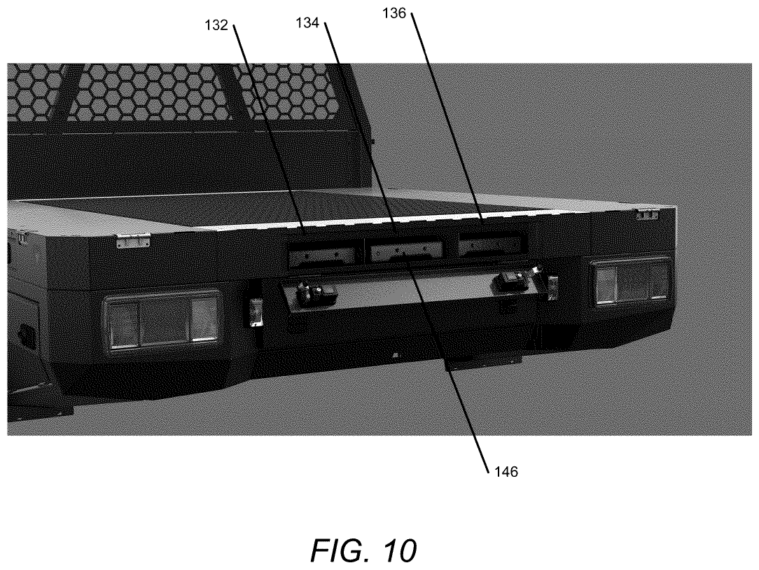

FIG. 10 illustrates a middle section of a vehicle bed, according to various examples of the present disclosure. In various embodiments, the middle section 126 comprises a first side storage compartment 132, a middle storage compartment 134, and a second side storage compartment 136. The first side storage compartment 132, the middle storage compartment 134, and the second side storage compartment 136 are accessible from the rear end 108 of the vehicle bed 100 through a door 130 hingedly coupled to the vehicle bed 100. Further, a lock 138 may be coupled to the door 130 for securing each storage compartment. In many embodiments, a foam insert (not shown) can be coupled to each storage compartment to complement the shape of the removable side panel 146. For example, a foam insert can be coupled to the middle storage compartment 134 to complement the removal side panel 146 that is shorter than the length of the middle storage compartment 134. The foam insert may prevent the removable side panel 146 from moving during transport, which may prevent the removal side panel 146 from being scratched or dented. In a number of embodiments, the first side storage compartment 132, the middle storage compartment 134, and the second side storage compartment 136 may further comprise rubber mats inside each compartment. The rubber mat may not complement the cargo but prevent damage by lining the inside of the storage compartments. After storing the removal side panel 146 within a storage compartment, a user may re-mount the removable side panel 146 to the vehicle bed 100. Further, a user may use the removable side panel 146 as a ramp for loading cargo into the vehicle bed 100.

FIG. 11 illustrates a removable side panel, according to various examples of the present disclosure. The removable side panel 146 comprises an inner panel 160 having a first end 162 and a second end 164 (not shown). The removable side panel 146 further comprises an outer panel 166 having a first end 168 and a second end 170 (not shown). When mounted to the vehicle bed, the first end 162 of the inner panel 160 and the first end 168 of the outer panel 166 correspond to the first end 148 of the removable side panel 146. Similarly, the second end 164 of the inner panel 160 and the second end 170 of the outer panel 166 correspond to the second end 150 of the removable side panel 146. In many embodiments, the inner panel 160 and the outer panel 166 further comprises a plurality of holes 204. The plurality of holes 204 may provide a number of advantageous properties, including increase strength. Further, the plurality of holes 204 decreases the weight of the removable side panel 146 allowing the user to handle the removable side panel 146 more easily.

The removable side panel 146 can be used as a ramp to load cargo onto the vehicle bed 100. Further, the removable side panel 146 is configured to extend to provide an increased length for loading. Namely, the first end 162 of the inner panel 160 may extend from the first end 168 of the outer panel 166 increasing the length of the removable side panel 146. In an example, the removable side panel 146 is removed from to the vehicle bed 100, such that the first latch 176, the second latch 178, and the at least one hinge 180 are uncoupled from the vehicle bed 100. A user may then extend the first end 162 of the inner panel 160 from the first end 168 of the outer panel 166.

In many embodiments, the inner panel 160 further comprises an engaging member 196 on the first end 162 of the inner panel 160. The engaging member 196 may couple the first end 162 of the inner panel 160 to the rear end 108 of the vehicle bed 100 to function as a ramp. Further, the second end 170 of the outer panel 166 may contact the ground on any other surface where the cargo is being loaded. In an example, the first end 162 of the inner panel 160 couples to the rear end 108 of the vehicle bed 100, and the second end 170 of the outer panel 166 contacts the ground to create a ramp for loading cargo.

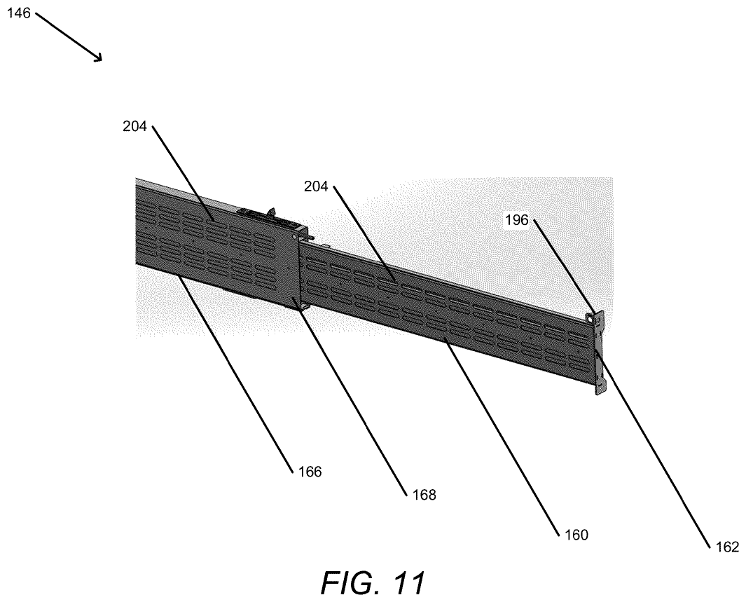

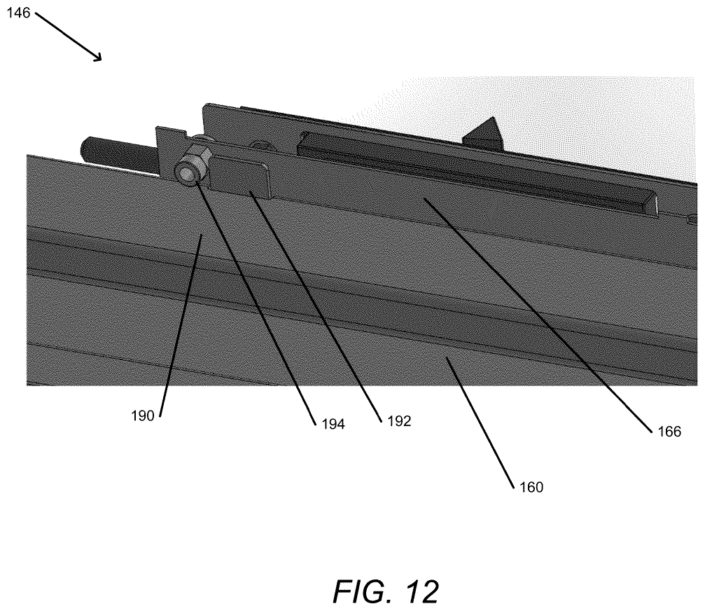

FIG. 12 illustrates a removable side panel having a lock assembly, according to various examples of the present disclosure. The removable side panel 146 may further include a lock assembly 190 having a notch 192 and a protrusion 194. The notch 192 may be located on the inner panel 160, and the protrusion 194 may be located on the outer panel 166. The lock assembly 190 may prevent the inner panel 160 from over extending, such that the inner panel 160 disconnects from the outer panel 166. When a user extends the inner panel 160, the inner panel 160 may be extended until the notch 192 engages the protrusion 194. The protrusion 194 acts as a barrier to the notch 192, which prevents the inner panel 160 from further extending. In various embodiments, the lock assembly 190 only prevents the inner panel 160 from over extending. A user may desire to extend the inner panel 160 shorter than the maximum length. For example, if a barrier prevents the user from full extending the removable side panel 146, the user may choose to partially extend the inner panel 160 from the outer panel 166 and load cargo with space constraints. Further, the removable side panel 146 may be used without extending the inner panel 160 from the outer panel 166.

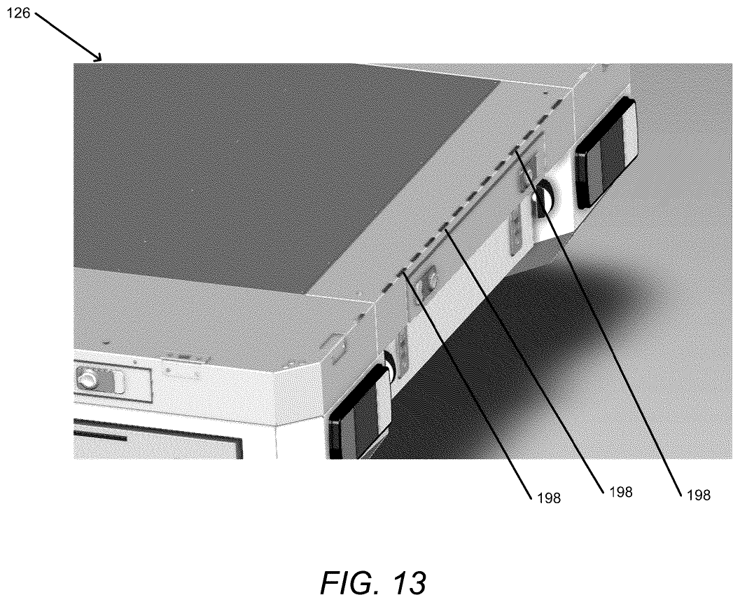

FIG. 13 illustrates a middle section of a vehicle bed, according to various examples of the present disclosure. In various embodiments, the middle section 126 of the vehicle bed 100 may further comprises a plurality of slots 198 to couple the engaging member 196 on the first end 162 of the inner panel 160 to the rear end 108 of the vehicle bed 100. In an example, a user removes the removable side panel 146 from the vehicle bed 100 and couples the first end 162 of the inner panel 160 to the rear end 108 of the vehicle bed 100 by guiding the engaging member 196 into one of the plurality of slots 198. After guiding the engaging member 196 into one of the plurality of slots 198, the user may extend the removable side panel 146 to a desired length. In another example, the user may extend the removable side panel 146 to a desired length and then guide the engaging member 196 into one of the plurality of slots 198. In many embodiments, the plurality of slots 198 can function to provide a ramp with varying width. In an example, a user is loading a vehicle. To match the width of the wheelbase of the vehicle for easy loading, the engaging member 196 can couple to one of the plurality of slots 198 that matches the width of the wheel base.

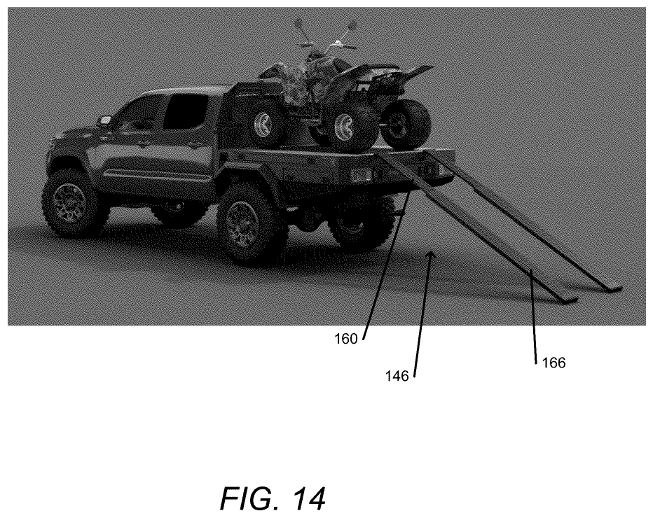

FIG. 14 illustrates a vehicle bed, according to various examples of the present disclosure. In an example, a use removes the removable side panel 146 to use the removable side panel 146 as a ramp to load cargo. In many embodiments, the user may remove the removable side panel 146. Then, a user may extend the inner panel 160 and couple the engaging member 196 on the first end 162 of the inner panel 160 to the rear end 108 of the vehicle bed 100 by guiding the engaging member 196 into one of a plurality of slots 198.

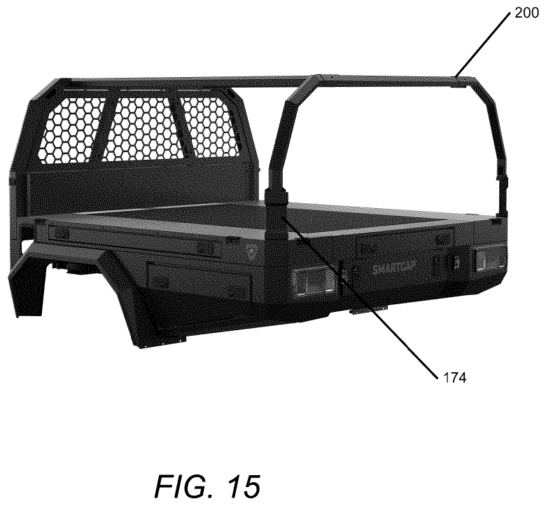

FIG. 15 illustrates a vehicle bed having an adventure rack, according to various examples of the present disclosure. In many embodiments, the vehicle bed 100 may further comprise an adventure rack 200. The adventure rack 200 is coupled to the post 174 on the top surface 102 of the vehicle bed. The adventure rack 200 is removable. For example, a user may remove the adventure rack 200 leaving the post 174 coupled to the top surface 102 of the vehicle bed 100. The adventure rack 200 can be used in combination the removable side panel 146. Thus a user may use the vehicle bed 100 with an adventure rack 200 and a removable side panel 146, with one attachment, or with neither attachment.

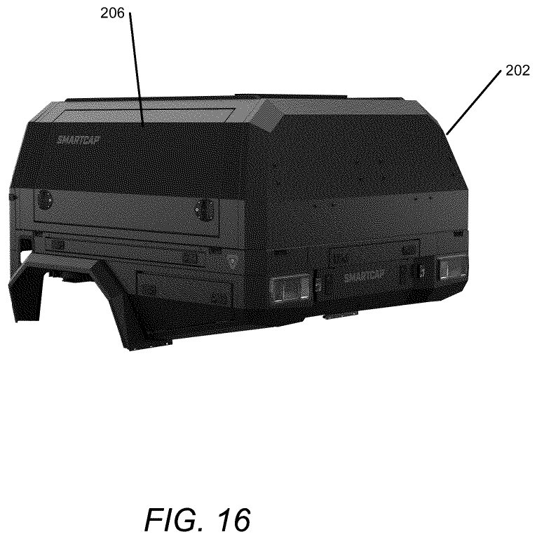

FIG. 16 illustrates a vehicle bed having a cap system, according to various examples of the present disclosure. In many embodiments, the vehicle bed 100 may further comprise a cap system 202. The cap system 202 may further comprise a panel 206, which can be opened and closed. The cap system 202 mounts to the top surface 102 of the vehicle bed 100. In an example, the cap system 202 may comprise a plurality of mounting components that engage the plurality of interior apertures 142 on the top surface 102 of the vehicle bed 100. Further, the plurality of mounting components may additionally engage the plurality of corner apertures 144 located on the top surface 102 of the vehicle bed 100.

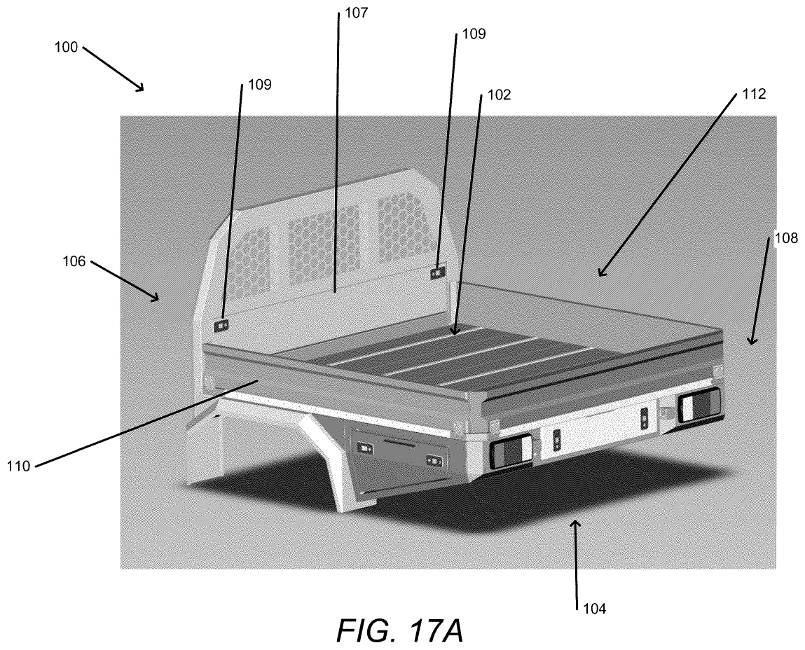

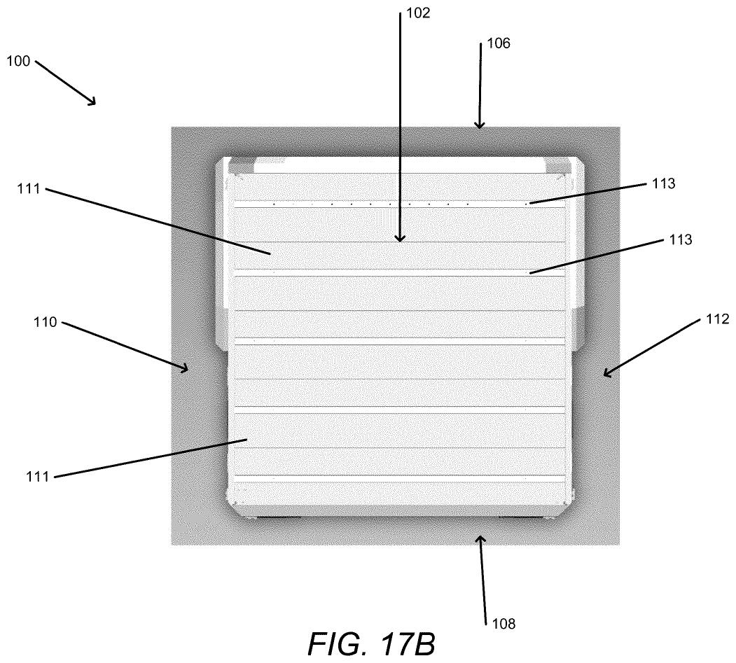

FIGS. 17A-B illustrate vehicle beds, according to various examples of the present disclosure. The vehicle bed 100 comprises a top surface 102, a bottom surface 104, a front end 106, a rear end 108, a first side 110, and a second side 112. When mounted on a vehicle, the front end 106 may be directly adjacent to the vehicle cabin while the rear end 108 is adjacent to the rear of the vehicle. In many embodiments, the vehicle bed 100 includes a rear compartment 107 adjacent to the front end 106 of the vehicle bed 100. The rear compartment 107 may optionally include at least one lock 109 to secure the compartment. In various embodiments, the number and the orientation of the at least one lock 109 can be altered.

As shown in FIG. 17B, the top surface 102 may include a plurality of horizontal panels 111 that are perpendicular to the chassis of the vehicle. The plurality of horizontal panels 111 may decrease the weight of the top surface 102 and provide for a more efficient assembly process. The top surface 102 may also include a plurality of apertures 113. Any number of components can engage the plurality of apertures 113. For example, an eye bolt can engage a corresponding apertures and then be used to tie down cargo. In an example embodiment, apertures 113 are provided in parallel rows (e.g., 5 rows) presenting a wide range of tie down options.

Although the vehicle bed 100 has been described in certain specific aspects, many additional modifications and variations would be apparent to those skilled in the art. In particular, any of the various processes described above can be performed in alternative sequences and/or in parallel in order to achieve similar results in a manner that is more appropriate to the requirements of a specific application. It is therefore to be understood that the present disclosure can be practiced otherwise than specifically described without departing from the scope and spirit of the present embodiments. Thus, embodiments of the present invention should be considered in all respects as illustrative and not restrictive. It will be evident to the annotator skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled annotator, except where expressly required. Accordingly, the scope of the invention should be determined not by the embodiments illustrated, but by the appended claims and their equivalents.

The invention is claimed as follows:

1. A vehicle bed comprising:
a top surface;
a front end and a rear end;
a first side and a second side; and
a removable side panel with a first end, a second end, a top side, a bottom side, an interior side, and an exterior side.

2. The vehicle bed of claim 1, wherein the removable side panel comprises:
an inner panel having a first end and a second end coupled to an outer panel having a first end and a second end, wherein the first end of the inner panel is configured to extend from and retract into the first end of the removable side panel.

3. The vehicle bed of claim 1, wherein at least one hinge couples the bottom side of the removable side panel to the top surface of the vehicle bed.

4. The vehicle bed of claim 3, wherein the at least one hinge comprises a spring.

5. The vehicle bed of claim 1, wherein a first coupling couples the first end of the removable side panel to a front structure of the vehicle bed.

6. The vehicle bed of claim 5, wherein the first coupling comprises a first latch configured to extend and retract a component to engage the front structure of the vehicle bed.

7. The vehicle bed of claim 1, wherein a second coupling couples the second end of the removable side panel to a post on the top surface of the vehicle bed.

8. The vehicle bed of claim 7, wherein the second coupling comprises a second latch configured to extend and retract a component to engage an aperture in the post.

9. The vehicle bed of claim 1, wherein a second coupling couples the second end of the removable side panel to a rear panel of the vehicle bed.

10. The vehicle bed of claim 2, wherein the first end of the inner panel comprises an engaging member to engage at least one of a plurality of slots on the top surface of the rear end of the vehicle bed.

11. The vehicle bed of claim 2, wherein the outer panel further comprises a plurality of ridges and the inner panel further includes a plurality of ridges.

12. The vehicle bed of claim 2, wherein the inner panel further comprises a notch and the outer panel further comprises a protrusion wherein the notch is configured to contact the protrusion to prevent overextension.

13. The vehicle bed of claim 1, wherein a third coupling couples the removable side panel to the vehicle bed.

14. The vehicle bed of claim 1, wherein a third coupling is configured to enable rotation of the removable side panel with respect to the vehicle bed such that a surface of the interior side of the removable side panel is approximately co-planar with the top surface of the vehicle bed.

15. The vehicle bed of claim 1, further comprising a first side section, a middle section, and a second side section.

16. The vehicle bed of claim 1, wherein the first side of the vehicle bed comprises a drawer.

17. The vehicle bed of claim 1, wherein the first side of the vehicle bed comprises a first side storage compartment.

18. The vehicle bed of claim 1, further comprising a first side section, a second side second, and a middle section having a first side storage compartment, a middle storage compartment, and a second side storage compartment.

19. The vehicle bed of claim 18, wherein the middle section further comprises a plurality of inserts to complementarily engage the removal side panel.

20. The vehicle bed of claim 1, further comprising a plurality of interior apertures on the top surface of the vehicle bed.
